(19) United States
(12) Patent Application Publication
(10) Pub. No.: US 2021/0370423 A1
(43) Pub. Date: Dec. 2, 2021

(54) Apparatus, Systems, and Methods for Forming Aligned Holes From Misaligned Holes

(71) Applicant: The Boeing Company, Chicago, IL (US)

(72) Inventors: John P. Scheibel, Florissant, MO (US); James L. Scherer, St. Peters, MO (US); Michael A. Ward, University City, MO (US)

(21) Appl. No.: 16/884,506

(22) Filed: May 27, 2020

(51) Int. Cl. B23D 77/14; B23B 35/00

(52) U.S. Cl. CPC B23D 77/14; B23B 35/00

(57) ABSTRACT

Apparatus, systems, and methods for forming a plurality of aligned holes from a plurality of misaligned holes. The apparatus includes a reamer with a constant diameter a first portion and a tapered second portion. A constant diameter pilot member is connected to the reamer. The taper may be configured to center the reamer and reduce an offset between the apparatus and a centerline of a virtual hole created by the misaligned holes. The constant diameter of the pilot member corresponds to the virtual hole and the constant diameter of the first portion of the reamer correspond to a cleanup hole configured to accept an oversize fastener and fully encompass the misaligned holes. If the pilot member cannot pass through the misaligned holes, an apparatus with a smaller diameter pilot member and a larger diameter reamer is needed to create a cleanup hole that fully encompasses the misaligned holes.

### BACKGROUND

### Field of the Disclosure

The examples described herein relate to apparatus, systems, and methods for forming a plurality of aligned holes from a plurality of misaligned holes.

### Description of the Related Art

When multiple objects are to be connected together, fasteners of various sizes are commonly used. Circular holes are drilled into each object and the objects are then placed adjacent to each other so that the respective holes overlap. Ideally, the holes through the objects are aligned and a designated fastener may be inserted through the holes to secure the objects together. However, when the holes through the objects are misaligned, the designated fastener may not be able to be inserted through the holes depending on the degree of misalignment.

A common technique for correcting misaligned holes is to drill or ream a cleanup hole through the misaligned holes. The cleanup hole is generally centered on one of the misaligned holes and is preferably large enough in diameter to fully encompass all of the misaligned holes. Once the cleanup hole has been created, a larger fastener may be used to secure the multiple objects together. Conventionally, cleanup holes have been created on a trial-and-error basis with incrementally larger cleanup holes being drilled or reamed until the cleanup hole fully encompasses the misaligned holes. This is a time-consuming process and also may result in a larger than necessary cleanup hole being formed through the multiple objects. Other disadvantages may exist.

### SUMMARY

The present disclosure is directed to apparatus, systems, and methods for forming a plurality of aligned holes from a plurality of misaligned holes.

One example of the present disclosure is an apparatus for forming a plurality of aligned holes from a plurality of misaligned holes. The apparatus comprises a reamer. The reamer has a first portion and a second portion, the first portion having a first constant diameter and the second portion having a first end and a second end. The first end of the second portion being adjacent to the first portion of the reamer. The second portion of the reamer being tapered and having a varied diameter that decreases from the first end to the second end. The apparatus includes a pilot member connected to the second end of the second portion of the reamer. The pilot member has a second constant diameter.

The second portion of the reamer may be configured to center the reamer on a centerline of a virtual hole. The taper of the second portion of the reamer may be configured to reduce an offset between a central longitudinal axis of the apparatus and the centerline of the virtual hole. The taper of the second portion of the reamer may include a beginning diameter which is larger than a final diameter. The taper of the second portion may taper from the final diameter to the beginning diameter at an angle of between about 0.5 degrees and about 1.0 degrees per side.

The second constant diameter may correspond to a first virtual hole and the first constant diameter may correspond to a first cleanup hole that accepts a first oversize fastener. The second constant diameter may correspond to a second virtual hole and the first constant diameter may correspond to a second cleanup hole that accepts a second oversize fastener. The second constant diameter may correspond to a third virtual hole and the first constant diameter may correspond to a third cleanup hole that accepts a third oversize fastener.

One example of the present disclosure is a system for forming a plurality of aligned holes from a plurality of misaligned holes. The system includes a first reamer that has a first portion and a second portion. The first portion of the first reamer has a first constant diameter. The second portion of the first reamer has a first end and a second end. The first end of the second portion of the first reamer is adjacent to the first portion of the first reamer. The second portion of the first reamer is tapered having a varied diameter that decreases from the first end to the second end. The system includes a first pilot member connected to the second end of the second portion of the first reamer. The first pilot member has a second constant diameter that corresponds to a first virtual hole and the first constant diameter of the first reamer corresponds to a first cleanup hole that accepts a first oversize fastener.

The system includes a second reamer that has a first portion and a second portion. The first portion of the second reamer has a third constant diameter. The second portion of the second reamer has a first end and a second end. The first end of the second portion of the second reamer is adjacent to the first portion of the second reamer. The second portion of the second reamer is tapered and has a varied diameter that decreases from the first end to the second end. The system includes a second pilot member. The second pilot member is connected to the second end of the second portion of the second reamer. The second pilot member has a fourth constant diameter that corresponds to a second virtual hole. The third constant diameter of the second reamer corresponds to a second cleanup hole that accepts a second oversize fastener. The second oversize fastener has a larger diameter than the first oversize fastener.

The taper of the second portion of the first reamer may be configured to center the first reamer on a centerline of a first virtual hole. The taper of the second portion of the second reamer may be configured to center the second reamer on a centerline of a second virtual hole. The taper of the second portion of the first reamer may have a first beginning diameter and a first final diameter. The first beginning diameter may be substantially identical to the first constant diameter and the first final diameter may be substantially identical to the second constant diameter. The taper of the second portion of the second reamer may have a second beginning diameter and a second final diameter. The second beginning diameter may be substantially identical to the third constant diameter and the second final diameter may be substantially identical to the fourth constant diameter.

The second portion of the first reamer may taper from the first final diameter to the first beginning diameter at an angle of between about 0.5 degrees and about 1.0 degrees per side. The second portion of the second reamer may taper from the second final diameter to the second beginning diameter at an angle of between about 0.5 degrees and about 1.0 degrees per side.

The system may include a third reamer that has a first portion and a second portion. The first portion of the third reamer has a fifth constant diameter. The second portion of the third reamer has a first end and a second end. The first end of the second portion of the third reamer is adjacent to the first portion of the third reamer. The second portion of the third reamer is tapered having a varied diameter that decreases from the first end to the second end. The system may include a third pilot member connected to the second end of the second portion of the third reamer. The third pilot member has a sixth constant diameter that corresponds to a third virtual hole and the fifth diameter of the third reamer corresponds to a third cleanup hole that accepts a third oversize fastener. The third oversize fastener has a larger diameter than the second oversize fastener. The taper of the second portion of the third reamer may have a third beginning diameter and a third final diameter. The third beginning diameter may be substantially identical to the fifth constant diameter and the third final diameter may be substantially identical to the sixth constant diameter. The second portion of the third reamer may taper from the third final diameter to the third beginning diameter at an angle of between about 0.5 degrees and about 1.0 degrees per side.

One example of the present disclosure is a method for creating aligned holes from a plurality of misaligned holes. The method includes attempting to insert a first pilot member through the plurality of misaligned holes. The first pilot member is connected to a first reamer that includes a first portion and a second portion. The second portion of the first reamer has a first end and a second end. The first end of the second portion is adjacent to the first portion of the first reamer. The first portion of the first reamer has a first constant diameter. The second portion of the first reamer is tapered having a varied diameter that decreases from the first end to the second end. The first pilot member is connected to the second end of the second portion of the first reamer. The first pilot member has a second constant diameter that corresponds to a first virtual hole diameter and the first constant diameter of the first reamer corresponds to a first cleanup hole that accepts a first fastener. The method includes cutting the first cleanup hole through the plurality of misaligned holes with the first reamer as the first pilot member is inserted into the plurality of misaligned holes.

If the first pilot member cannot be inserted through the plurality of misaligned holes, the method may include attempting to insert a second pilot member into the plurality of misaligned holes. The second pilot member is connected to a second reamer that includes a first portion and a second portion. The second portion of the second reamer has a first end and a second end. The first end of the second portion of the second reamer is adjacent to the first portion of the second reamer. The first portion of the second reamer has a third constant diameter. The second portion of the second reamer is tapered having a varied diameter that decreases from the first end to the second end. The second pilot member is connected to the second end of the second portion of the second reamer. The second pilot member has a fourth constant diameter that corresponds to a second virtual hole and wherein the third constant diameter of the second reamer corresponds to a second cleanup hole that accepts a second fastener. The method may include cutting the second cleanup hole through the plurality of misaligned holes with the second reamer as the second pilot member is inserted into the plurality of misaligned holes.

If the second pilot member cannot be inserted through the plurality of misaligned holes, the method may include attempting to insert a third pilot member into the plurality of misaligned holes. The third pilot member is connected to a third reamer that has a first portion and a second portion. The second portion has a first end and a second end. The first end of the second portion is adjacent to the first portion of the third reamer. The first portion of the third reamer has a fifth constant diameter and the second portion of the third reamer is tapered having a varied diameter that decreases from the first end to the second end. The third pilot member is connected to the second end of the second portion of the third reamer. The third pilot member has a sixth constant diameter that corresponds to a third virtual hole and the fifth constant diameter of the third reamer corresponds to a third cleanup hole that accepts a third fastener. The method may include cutting the third cleanup hole through the plurality of misaligned holes with the third reamer as the third pilot member is inserted into the plurality of misaligned holes. The method may include inserting a first oversize fastener through the first cleanup hole. Other embodiments also exist.

### BRIEF DESCRIPTION OF THE DRAWINGS

FIG. 1 is a schematic of an example apparatus for forming a plurality of aligned holes from a plurality of misaligned holes.

FIG. 2 is a schematic of two parts each having a hole with the holes being aligned.

FIG. 3A-3C are schematics showing two holes that are misaligned.

FIGS. 4A-4C are schematics of example apparatus for forming a plurality of aligned holes from a plurality of misaligned holes.

FIGS. 5A-5C are schematics of a system for forming a plurality of aligned holes from a plurality of misaligned holes.

FIG. 6 is a flow chart for an example method for forming a plurality of aligned holes from a plurality of misaligned holes.

While the disclosure is susceptible to various modifications and alternative forms, specific embodiments have been shown by way of example in the drawings and will be described in detail herein. However, it should be understood that the disclosure is not intended to be limited to the particular forms disclosed. Rather, the intention is to cover all modifications, equivalents and alternatives falling within the scope of the disclosure as defined by the appended claims.

### DETAILED DESCRIPTION

The embodiments described herein can be used to form a plurality of aligned holes from a plurality of misaligned holes. As used herein, a plurality of misaligned holes means two or more holes through which a specified fastener may not be inserted completely through due to the misalignment of the holes. As used herein, an oversize fastener is a fastener having a larger diameter than the diameter of the specified fastener intended to be inserted through a plurality of holes to fastened together two or more parts.

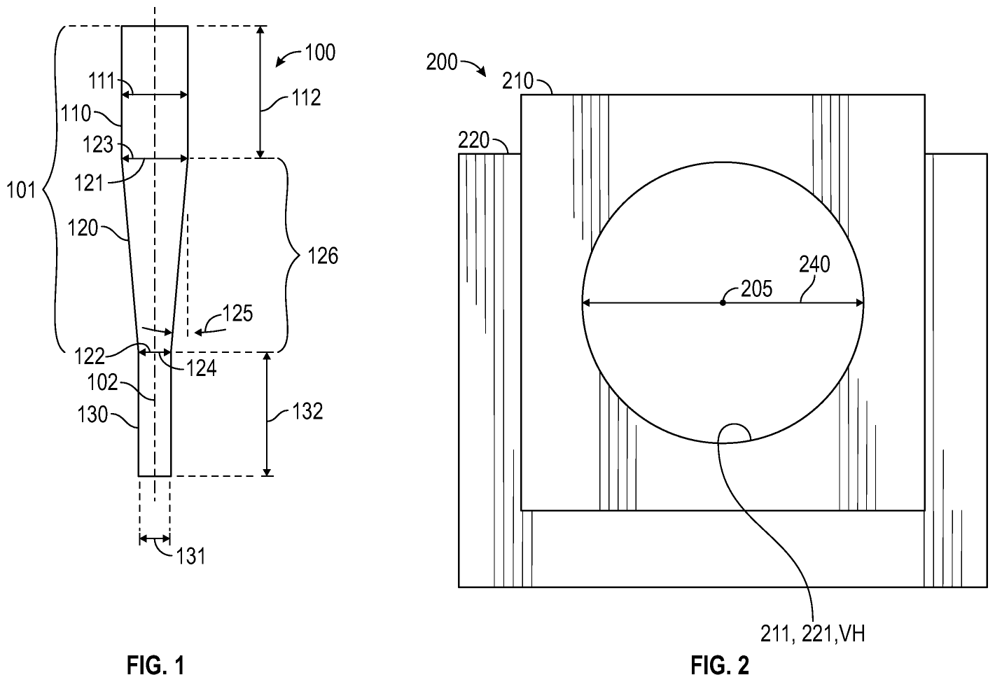

FIG. 1 is a schematic of an example apparatus 100 for forming a plurality of aligned holes from a plurality of misaligned holes. The apparatus 100 comprises a reamer 101. The reamer 101 has a first portion 110 and a second portion 120. The first portion 110 has a first constant diameter 111. The second portion 120 has a first end 121 and a second end 122. The first end 121 of the second portion 120 is adjacent to the first portion 110 of the reamer 101. The second portion 120 of the reamer 101 is tapered 126 having a varied diameter 123-124 that decreases from the first end 121 to the second end 122. The apparatus 100 includes a pilot member 130 connected to the second end 122 of the second portion 120 of the reamer 101. The pilot member 130 has a second constant diameter 131.

The first portion 110 of the reamer 101 has a first length 112. The pilot member 130 has a second length 132. The second portion 120 of the reamer 101 is configured to center the reamer 101 on a centerline 205 of a virtual hole VH. The taper 126 of the second portion 120 of the reamer 101 is configured to reduce an offset between a central longitudinal axis 102 of the apparatus 100 and the centerline 205 of the virtual hole VH. The taper 126 of the second portion 120 of the reamer 101 may include a beginning diameter 123 which is larger than a final diameter 124. The taper 126 of the second portion 120 tapers from the final diameter 124 to the beginning diameter 123 at an angle 125 of between about 0.5 degrees and about 1.0 degrees per side.

The second constant diameter 131 may correspond to a first virtual hole VH-A and the first constant diameter 111 may correspond to a first cleanup hole 230A that accepts a first oversize fastener. The second constant diameter 131 may correspond to a second virtual hole VH-B and the first constant diameter 111 may correspond to a second cleanup hole 230B that accepts a second oversize fastener. The second constant diameter 131 may correspond to a third virtual hole VH-C and the first constant diameter 111 may correspond to a third cleanup hole 230C that accepts a third oversize fastener.

FIG. 2 is a schematic of a system 200 having two parts 210, 220 each having a hole 211, 221 with the holes 211, 221 being aligned. The holes 211, 221 form a virtual hole VH having a diameter 240 and a centerline 205. If the holes 211, 221 are aligned, the virtual hole VH is the same as the individual diameters of each of the holes 211, 221. A fastener specified to connect the two parts 210, 220 together may be able to be inserted through the holes 211, 221 to secure the parts 210, 220 together. The area of the virtual hole VH through the plurality of holes 211, 221 decreases as the degree of misalignment between the two holes 211, 221 increases.

At a particular degree of misalignment, the specified fastener will not be able to be inserted through both of the holes 211, 221. In this instance, an apparatus, such as apparatus 100 of FIG. 1, can create a cleanup hole that has a diameter that encompasses each of the misaligned holes 211, 221. The cleanup hole will enable an oversize fastener to be inserted through the cleanup hole to secure the two parts 210, 220 together. The number, size, location, shape, and/or configuration of the parts 210, 220, virtual hole VH, and holes 211, 221 in FIG. 2 are shown for illustrative purposes and may be varied depending on the application.

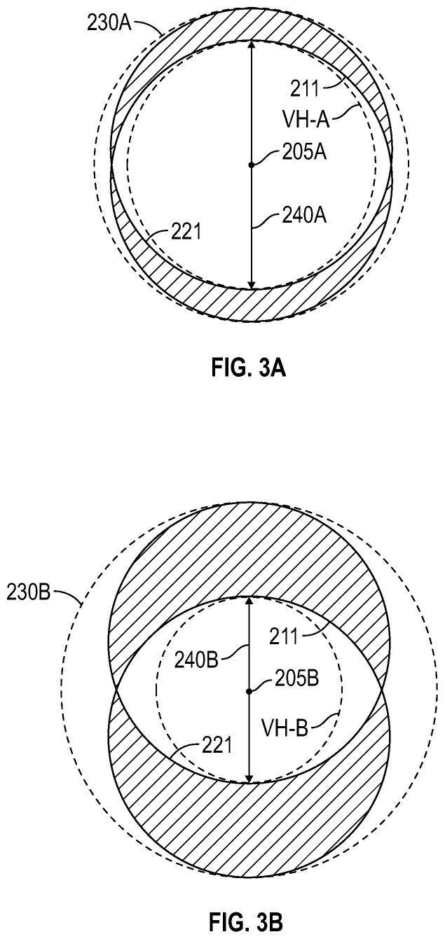

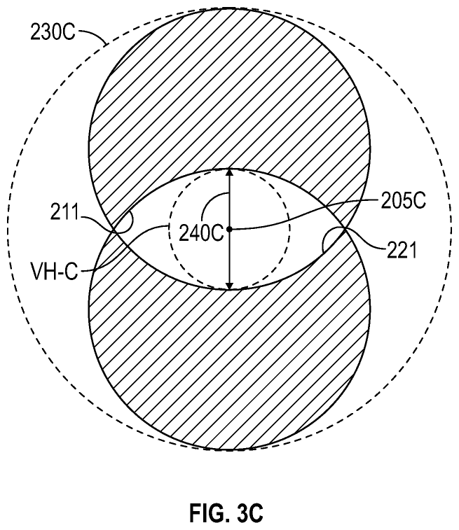

FIG. 3A is a schematic showing two holes 211, 221 that are misaligned. Other parts are not included in the schematic for clarity purposes. The misalignment of the two holes 211, 221 results in creating a first virtual hole VH-A that has a smaller diameter 240A that the diameter of each of the two holes 211, 221. The first virtual hole VH-A has a centerline 205A. When the two holes 211, 221 are misaligned creating the first virtual hole VH-A, a first cleanup hole 230A is necessary to encompass both of the holes 211, 221. The first cleanup hole 230A is configured to enable the insertion of a first oversize fastener through the first cleanup hole 230A.

FIG. 3B is a schematic showing two holes 211, 221 that are misaligned to a greater degree than the two holes 211, 221 shown in FIG. 3A. Other parts are not included in the schematic for clarity purposes. The misalignment of the two holes 211, 221 results in creating a second virtual hole VH-B that has a smaller diameter 240B than the diameters of the two holes 211, 221. The diameter 240B of the second virtual hole VH-B is also smaller than the diameter 240A of the first virtual hole VH-A. The second virtual hole VH-B has a centerline 205B. When the two holes 211, 221 are misaligned creating the second virtual hole VH-B, a second cleanup hole 230B is necessary to encompass both of the holes 211, 221. The second cleanup hole 230B is larger than the first cleanup hole 230A. The second cleanup hole 230B is configured to enable the insertion of a second oversize fastener through the second cleanup hole 230B. The diameter of the second oversize fastener is larger than the diameter of the first oversize fastener.

FIG. 3C is a schematic showing two holes 211, 221 that are misaligned to a greater degree than the two holes 211, 221 shown in FIG. 3B. Other parts are not included in the schematic for clarity purposes. The misalignment of the two holes 211, 221 results in creating a third virtual hole VH-C that has a smaller diameter 240C than the diameters of the two holes 211, 221. The diameter 240C of the third virtual hole VH-C is also smaller than the diameter 240B of the second virtual hole VH-B. The third virtual hole VH-C has a centerline 205C. When the two holes 211, 221 are misaligned creating the third virtual hole VH-B, a third cleanup hole 230C is necessary to encompass both of the holes 211, 221. The third cleanup hole 230C is larger than the second cleanup hole 230B. The third cleanup hole 230C is configured to enable the insertion of a third oversize fastener through the third cleanup hole 230B. The diameter of the third oversize fastener is larger than the diameter of the second oversize fastener.

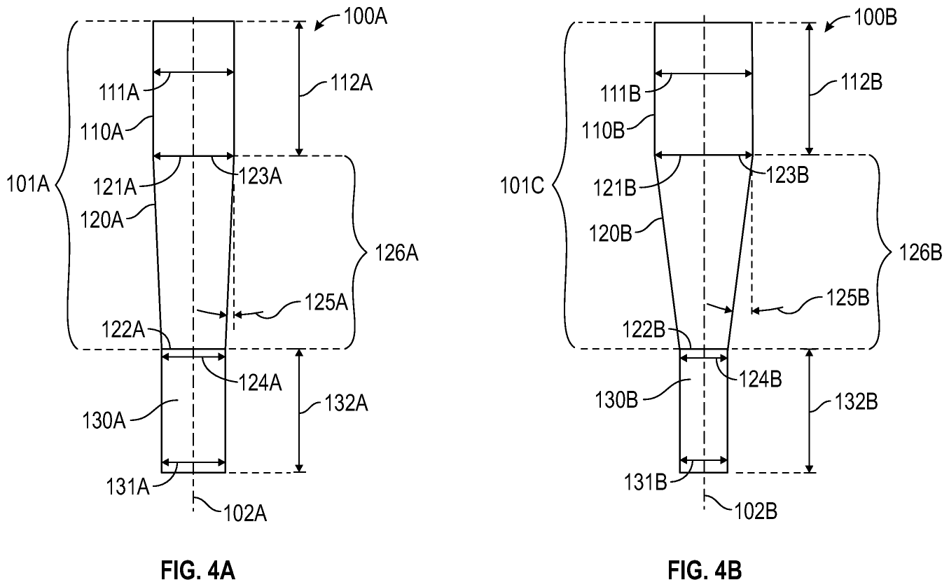

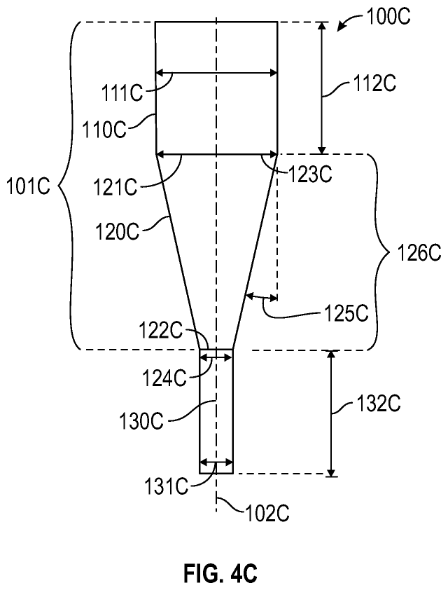

FIGS. 4A-4C are schematics of example apparatus for forming a plurality of aligned holes from a plurality of misaligned holes. The apparatus of FIG. 4A may be used to form a plurality of aligned holes from a plurality of misalign holes 211, 221 that form a first virtual hole VH-A. The apparatus of FIG. 4B may be used to form a plurality of aligned holes from a plurality of misalign holes 211, 221 that form a second virtual hole VH-B that is smaller than the first virtual hole VH-A. The apparatus of FIG. 4B may be used to form a plurality of aligned holes from a plurality of misalign holes 211, 221 that form a third virtual hole VH-C that is smaller than the second virtual hole VH-B.

FIG. 4A is a schematic of an example apparatus 100A for forming a plurality of aligned holes from a plurality of misaligned holes. The apparatus 100A comprises a first reamer 101A. The first reamer 101A has a first portion 110A and a second portion 120A. The first portion 110A has a first constant diameter 111A. The second portion 120A has a first end 121A and a second end 122A. The first end 121A of the second portion 120A is adjacent to the first portion 110A of the first reamer 101A. The second portion 120A of the first reamer 101A is tapered 126A having a varied diameter 123A-124A that decreases from the first end 121A to the second end 122A. The apparatus 100A includes a first pilot member 130A connected to the second end 122A of the second portion 120A of the first reamer 101A. The first pilot member 130A has a second constant diameter 131A.

The first portion 110A of the first reamer 101A has a first length 112A. The first pilot member 130A has a second length 132A. The second portion 120A of the first reamer 101A is configured to center the first reamer 101A on a centerline 205A of a first virtual hole VH-A. The taper 126A of the second portion 120A of the first reamer 101A is configured to reduce an offset between a central longitudinal axis 102A of the apparatus 100A and the centerline 205A of the first virtual hole VH-A. The taper 126A of the second portion 120A of the first reamer 101A may include a beginning diameter 123A which is larger than a final diameter 124A. The taper 126A of the second portion 120A may taper from the final diameter 124A to the beginning diameter 123A at an angle 125A of between about 0.5 degrees and about 1.0 degrees per side.

The second constant diameter 131A corresponds to a minimum diameter 240A of a first virtual hole VH-A and the first constant diameter 111A corresponds to a first cleanup hole 230A that is configured to accept a first oversize fastener. The second constant diameter 131A is configured to correspond to a maximum misalignment between the two holes 211, 221 that may still be encompassed by the first cleanup hole 230A. In other words, the second constant diameter 131A is configured to correspond to the smallest diameter 240A of the first virtual hole VH-A that will still enable the cleanup hole 230A created by the first portion 110A of the first reamer 101A to fully encompass each of the misaligned holes 211, 221. If the first pilot member 130A may not be able to be inserted through the virtual hole VH-A created by the misaligned holes 211, 221, the cleanup hole 230A created by the first reamer 101A will not fully encompass each of the misaligned holes 211, 221.

FIG. 4B is a schematic of an example apparatus 100B for forming a plurality of aligned holes from a plurality of misaligned holes. The apparatus 100B comprises a second reamer 101B. The second reamer 101B has a first portion 110B and a second portion 120B. The first portion 110B has a third constant diameter 111B. The second portion 120B has a first end 121B and a second end 122B. The first end 121B of the second portion 120B is adjacent to the first portion 110B of the second reamer 101B. The second portion 120B of the second reamer 101B is tapered 126B having a varied diameter 123B-124B that decreases from the first end 121B to the second end 122B. The apparatus 100B includes a second pilot member 130B connected to the second end 122B of the second portion 120B of the second reamer 101B. The second pilot member 130B has a fourth constant diameter 131B.

The first portion 110B of the second reamer 101B has a third length 112B. The second pilot member 130B has a fourth length 132B. The second portion 120B of the second reamer 101B is configured to center the second reamer 101B on a centerline 205B of a second virtual hole VH-B. The taper 126B of the second portion 120B of the second reamer 101B is configured to reduce an offset between a central longitudinal axis 102B of the apparatus 100B and the centerline 205B of the second virtual hole VH-B. The taper 126B of the second portion 120B of the second reamer 101B may include a beginning diameter 123B which is larger than a final diameter 124B. The taper 126B of the second portion 120B may taper from the final diameter 124B to the beginning diameter 123B at an angle 125B of between about 0.5 degrees and about 1.0 degrees per side.

The fourth constant diameter 131B corresponds to a minimum diameter 240B of a second virtual hole VH-B and the third constant diameter 111B corresponds to a second cleanup hole 230B that is configured to accept a second oversize fastener. The fourth constant diameter 131B is configured to correspond to a maximum misalignment between holes 211, 221 that may still be encompassed by the second cleanup hole 230B. In other words, the fourth constant diameter 131B is configured to correspond to the smallest diameter 240B of the second virtual hole VH-B that will still enable the cleanup hole 230B created by the first portion 110B of the second reamer 101B to fully encompass each of the misaligned holes 211, 221. If the second pilot member 130B may not be able to be inserted through the virtual hole VH-B created by the misaligned holes 211, 221, the cleanup hole 230B created by the second reamer 101B will not fully encompass each of the misaligned holes 211, 221.

FIG. 4C is a schematic of an example apparatus 100C for forming a plurality of aligned holes from a plurality of misaligned holes. The apparatus 100C comprises a third reamer 101C. The third reamer 101C has a first portion 110C and a second portion 120C. The first portion 110C has a fifth constant diameter 111C. The second portion 120C has a first end 121C and a second end 122C. The first end 121C of the second portion 120C is adjacent to the first portion 110C of the third reamer 101C. The second portion 120C of the third reamer 101C is tapered 126C having a varied diameter 123C-124C that decreases from the first end 121C to the second end 122C. The apparatus 100C includes a third pilot member 130C connected to the second end 122C of the second portion 120C of the third reamer 101C. The third pilot member 130C has a sixth constant diameter 131C.

The first portion 110C of the third reamer 101C has a fifth length 112C. The third pilot member 130C has a sixth length 132C. The second portion 120C of the third reamer 101C is configured to center the third reamer 101C on a centerline 205C of a third virtual hole VH-C. The taper 126C of the second portion 120C of the third reamer 101C is configured to reduce an offset between a central longitudinal axis 102C of the apparatus 100C and the centerline 205C of the third virtual hole VH-C. The taper 126C of the second portion 120C of the third reamer 101C may include a beginning diameter 123C which is larger than a final diameter 124C. The taper 126C of the second portion 120C may taper from the final diameter 124C to the beginning diameter 123C at an angle 125C of between about 0.5 degrees and about 1.0 degrees per side.

The sixth constant diameter 131C corresponds to a minimum diameter 240C of a third virtual hole VH-C and the fifth constant diameter 111C corresponds to a third cleanup hole 230C that is configured to accept a third oversize fastener. The sixth constant diameter 131C is configured to correspond to a maximum misalignment between holes 211, 221 that may still be encompassed by the third cleanup hole 230C. In other words, the sixth constant diameter 131C is configured to correspond to the smallest diameter 240C of the third virtual hole VH-C that will still enable the cleanup hole 230C created by the first portion 110C of the third reamer 101C to fully encompass each of the misaligned holes 211, 221. If the third pilot member 130C may not be able to be inserted through the virtual hole VH-C created by the misaligned holes 211, 221, the cleanup hole created by the third reamer 101C will not fully encompass each of the misaligned holes 211, 221.

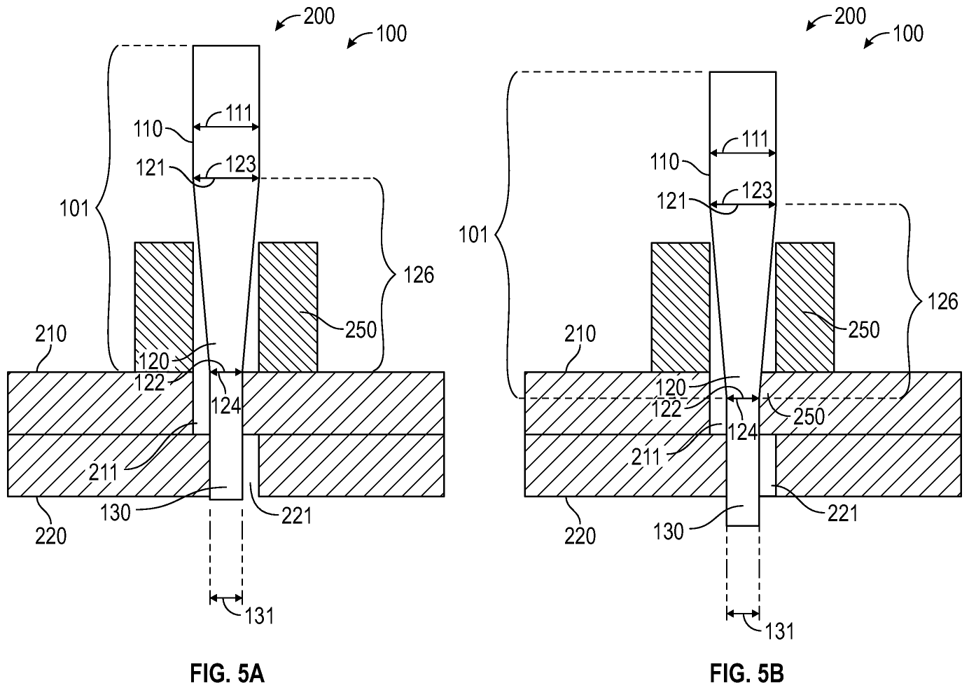

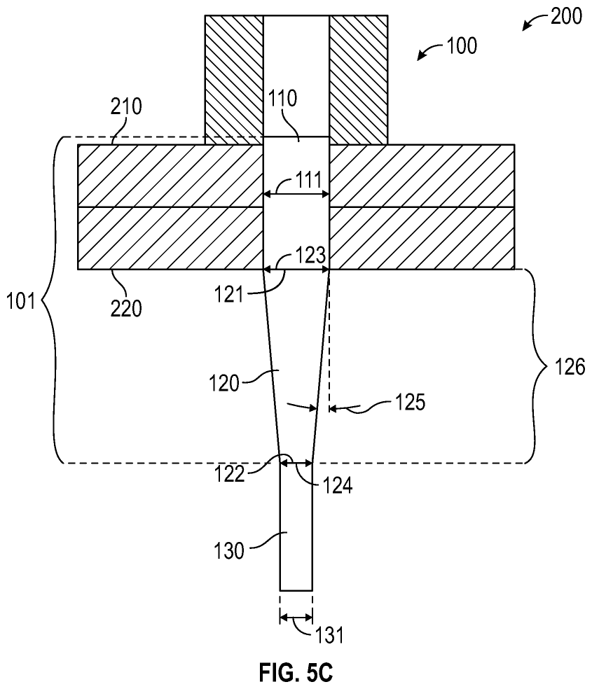

FIGS. 5A-5C are side view schematics of a system 200 for forming a plurality of aligned holes from a plurality of misaligned holes 211, 221. The hole 211 through a first part 210 is misaligned with the hole 221 through a second part 220. FIG. 5A shows the pilot member 130 positioned within the two misaligned holes 211, 221. A guide block 250 may be positioned on top of the first part 210 to guide the apparatus 100 to position the pilot member 130 within the two misaligned holes 211, 221. The pilot member 130 has a second constant diameter 131 that corresponds to a predetermined minimum virtual hole VH as discussed herein.

If the pilot member 130 is able to pass through the two misaligned holes 211, 221, the cleanup hole 230A, 230B, 230C that will be created by the first portion 110 of the reamer 101 will encompass both of the misaligned holes 211, 221. If the pilot member 130 is unable to pass through the two misaligned holes 211, 221, an apparatus 100 having a smaller pilot member 130 and a larger first portion 110 of the reamer 101 will need to be used to make a cleanup hole that encompasses both of the misaligned holes 211, 221. The first and second parts 210, 220 having two holes 211, 221 is shown in FIGS. 5A-5C for illustrative purposes and may be varied depending on the application. For example, the apparatus 100 may be used to form a plurality of aligned holes in two or more parts.

FIG. 5B shows a portion of the second portion 120 of the reamer 101 positioned within the misaligned holes 211, 221 of the first and second parts 210, 220. The second portion 120 of the reamer 101 is tapered 126 having a varied diameter 123-124 that decreases from the first end 121 to the second end 122. The second portion 120 of the reamer 101 will begin to form a cleanup hole 230A, 230B, 230C to the extent the tapered portion 126 of the second portion 120 of the reamer 101 contacts a sidewall of the two misaligned holes 211, 221. The second portion 120 of the reamer 101 is configured to center the reamer 101 on a centerline 205 of a virtual hole VH created by the misaligned holes 211, 221. The taper 126 of the second portion 120 of the reamer 101 is configured to reduce an offset between a central longitudinal axis 102 of the apparatus 100 and the centerline 205 of the virtual hole VH.

FIG. 5C shows the first portion 110 of the reamer 101 inserted through both the first part 210 and the second part 220 to cut two aligned cleanup holes through the parts 210, 220. The first portion 110 of the reamer 101 includes a constant diameter 111 that is configured to so that the two aligned holes in the parts 210, 220 create two aligned cleanup holes through the parts 210, 220 that fully encompass the misaligned holes 211, 221.

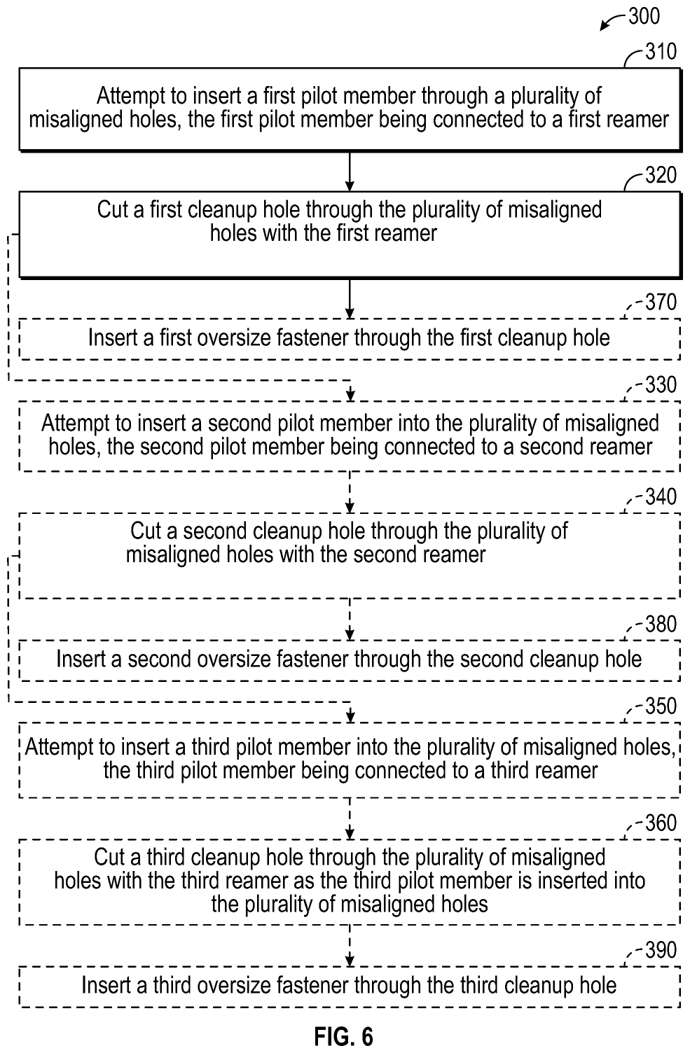

FIG. 6 is a flow chart of an example of a method 300 for creating a plurality of aligned holes from a plurality of misaligned holes. The method 300 includes attempting to insert a first pilot member 130A through a plurality of misaligned holes 211, 221, the first pilot member 130A being connected to a first reamer 101A, at 310. The first reamer 101A includes a first portion 110A and a second portion 120A. The second portion 120A has a first end 121A and a second end 122A being adjacent to the first portion 110A of the first reamer 101A. The first portion 110A of the first reamer 101A has a first constant diameter 111A. The second portion 120A is tapered 126A having a varied diameter 123A-124A that decreases from the first end 121A to the second end 122A. The first pilot member 130A is connected to the second end 122A of the second portion 120A of the first reamer 101A. The first pilot member 130A has a second constant diameter 131A that corresponds to a first virtual hole VH-A. The first constant diameter 111A of the first portion 110A of the first reamer 101A corresponds to a first cleanup hole 230A that accepts a first oversize fastener.

The method 300 includes cutting the first cleanup hole 230A through the plurality of misaligned holes 211, 221 with the first reamer 101A. For example, the first cleanup hole 230A is cut with the first reamer 101A as the first pilot member 130A is inserted into the plurality of misaligned holes 211, 221, at 320. If the first pilot member 130A is unable to pass through the plurality of misaligned holes 211, 221, the method 300 may include attempting to insert a second pilot member 130B into the plurality of misaligned holes, the second pilot member 130B being connected to a second reamer 101B, at 330. The second reamer 101B includes a first portion 110B and a second portion 120B. The second portion 120B has a first end 121B and a second end 122B being adjacent to the first portion 110B of the second reamer 101B. The first portion 110B of the second reamer 101B has a third constant diameter 111B. The second portion 120B is tapered 126B having a varied diameter 123B-124B that decreases from the first end 121B to the second end 122B. The second pilot member 130B is connected to the second end 122B of the second portion 120B of the second reamer 101B. The second pilot member 130B has a fourth constant diameter 131B that corresponds to a second virtual hole VH-B. The third constant diameter 111B of the first portion 110B of the second reamer 101B corresponds to a second cleanup hole 230B that accepts a second oversize fastener.

The method 300 may include cutting the second cleanup hole 230B through the plurality of misaligned holes 211, 221 with the second reamer 101B. For example, the second cleanup hole 230Bis cut with the second reamer 110B as the second pilot member 130B is inserted through the plurality of misaligned holes 211, 221, at 340. If the second pilot member 130B is unable to pass through the plurality of misaligned holes 211, 221, the method 300 may include attempting to insert a third pilot member 130C through the plurality of misaligned holes 211, 221, the third pilot member 130C being connected to a third reamer 101C, at 350.

The third reamer 101C includes a first portion 110C and a second portion 120C. The second portion 120C has a first end 121C and a second end 122C being adjacent to the first portion 110C of the third reamer 101C. The first portion 110C of the third reamer 101C has a fifth constant diameter 111C. The second portion 120C is tapered 126C having a varied diameter 123C-124C that decreases from the first end 121C to the second end 122C. The third pilot member 130C is connected to the second end 122C of the second portion 120C of the third reamer 101C. The third pilot member 130C has a sixth constant diameter 131C that corresponds to a third virtual hole VH-C. The fifth constant diameter 111C of the first portion 110C of the third reamer 101C corresponds to a third cleanup hole 230C that accepts a second oversize fastener.

The method 300 may include cutting the third cleanup hole 230C through the plurality of misaligned holes 211, 221 with the third reamer 101C as the third pilot member 130C is inserted through the plurality of misaligned holes 211, 221, at 360. The method 300 may include inserting a first oversize fastener through the first cleanup hole, at 370. The method 300 may include inserting a second oversize fastener through the second cleanup hole, at 380. The method 300 may include inserting a third oversize fastener through the third cleanup hole, at 390.

Although this disclosure has been described in terms of certain embodiments, other embodiments that are apparent to those of ordinary skill in the art, including embodiments that do not provide all of the features and advantages set forth herein, are also within the scope of this disclosure. Accordingly, the scope of the present disclosure is defined only by reference to the appended claims and equivalents thereof.

What is claimed is:

1. An apparatus for forming a plurality of aligned holes from a plurality of misaligned holes, the apparatus comprising:
a reamer having a first portion and a second portion, the first portion having a first constant diameter and the second portion having a first end and a second end, the first end of the second portion being adjacent to the first portion of the reamer, the second portion of the reamer being tapered having a varied diameter that decreases from the first end to the second end; and
a pilot member connected to the second end of the second portion of the reamer, the pilot member having a second constant diameter.

2. The apparatus of claim 1, wherein the second portion of the reamer is configured to center the reamer on a centerline of a virtual hole.

3. The apparatus of claim 2, wherein the taper of the second portion of the reamer is configured to reduce an offset between a central longitudinal axis of the apparatus and the centerline of the virtual hole.

4. The apparatus of claim 1, wherein the taper of the second portion of the reamer comprises a beginning diameter which is larger than a final diameter, the taper of the second portion tapering from the final diameter to the beginning diameter at an angle of between about 0.5 degrees and about 1.0 degrees per side.

5. The apparatus of claim 1, wherein the second constant diameter corresponds to a first virtual hole and wherein the first constant diameter corresponds to a first cleanup hole that accepts a first oversize fastener.

6. The apparatus of claim 1, wherein the second constant diameter corresponds to a second virtual hole and wherein the first constant diameter corresponds to a second cleanup hole that accepts a second oversize fastener.

7. The apparatus of claim 1, wherein the second constant diameter corresponds to a third virtual hole and wherein the first constant diameter corresponds to a third cleanup hole that accepts a third oversize fastener.

8. A system for forming a plurality of aligned holes from a plurality of misaligned holes, the system comprising:
a first reamer having a first portion and a second portion, the first portion of the first reamer having a first constant diameter, the second portion of the first reamer having a first end and a second end, the first end of the second portion of the first reamer being adjacent to the first portion of the first reamer, the second portion of the first reamer being tapered having a varied diameter that decreases from the first end to the second end;
a first pilot member connected to the second end of the second portion of the first reamer, the first pilot member having a second constant diameter that corresponds to a first virtual hole and wherein the first constant diameter of the first reamer corresponds to a first cleanup hole that accepts a first oversize fastener;
a second reamer having a first portion and a second portion, the first portion of the second reamer having a third constant diameter, the second portion of the second reamer having a first end and a second end, the first end of the second portion of the second reamer being adjacent to the first portion of the second reamer, the second portion of the second reamer being tapered having a varied diameter that decreases from the first end to the second end; and
a second pilot member connected to the second end of the second portion of the second reamer, the second pilot member having a fourth constant diameter that corresponds to a second virtual hole and wherein the third constant diameter of the second reamer corresponds to a second cleanup hole that accepts a second oversize fastener, the second oversize fastener having a larger diameter than the first oversize fastener.

9. The system of claim 8, wherein the taper of the second portion of the first reamer is configured to center the first reamer on a centerline of a first virtual hole and wherein the taper of the second portion of the second reamer is configured to center the second reamer on a centerline of a second virtual hole.

10. The system of claim 8, wherein the taper of the second portion of the first reamer has a first beginning diameter and a first final diameter, the first beginning diameter being substantially identical to the first constant diameter and the first final diameter being substantially identical to the second constant diameter.

11. The system of claim 10, wherein the taper of the second portion of the second reamer has a second beginning diameter and a second final diameter, the second beginning diameter being substantially identical to the third constant diameter and the second final diameter being substantially identical to the fourth constant diameter.

12. The system of claim 11, wherein the second portion of the first reamer tapers from the first final diameter to the first beginning diameter at an angle of between about 0.5 degrees and about 1.0 degrees per side.

13. The system of claim 12, wherein the second portion of the second reamer tapers from the second final diameter to the second beginning diameter at an angle of between about 0.5 degrees and about 1.0 degrees per side.

14. The system of claim 11, further comprising:
a third reamer having a first portion and a second portion, the first portion of the third reamer having a fifth constant diameter, the second portion of the third reamer having a first end and a second end, the first end of the second portion of the third reamer being adjacent to the first portion of the third reamer, the second portion of the third reamer being tapered having a varied diameter that decreases from the first end to the second end; and
a third pilot member connected to the second end of the second portion of the third reamer, the third pilot member having a sixth constant diameter that corresponds to a third virtual hole and wherein the fifth constant diameter of the third reamer corresponds to a third cleanup hole that accepts a third oversize fastener, the third oversize fastener having a larger diameter than the second oversize fastener.

15. The system of claim 14, wherein the taper of the second portion of the third reamer has a third beginning diameter and a third final diameter, the third beginning diameter being substantially identical to the fifth constant diameter and the third final diameter being substantially identical to the sixth constant diameter.

16. The system of claim 15, wherein the second portion of the third reamer tapers from the third final diameter to the third beginning diameter at an angle of between about 0.5 degrees and about 1.0 degrees per side.

17. A method for creating aligned holes from a plurality of misaligned holes, the method comprising:
attempting to insert a first pilot member through the plurality of misaligned holes, the first pilot member being connected to a first reamer having a first portion and a second portion, the second portion having a first end and a second end with the first end being adjacent to the first portion of the first reamer, the first portion of the first reamer having a first constant diameter and the second portion being tapered having a varied diameter that decreases from the first end to the second end, wherein the first pilot member is connected to the second end of the second portion of the first reamer and wherein the first pilot member has a second constant diameter that corresponds to a first virtual hole and wherein the first constant diameter of the first reamer corresponds to a first cleanup hole that accepts a first fastener; and
cutting the first cleanup hole through the plurality of misaligned holes with the first reamer as the first pilot member is inserted into the plurality of misaligned holes.

18. The method of claim 17, wherein if the first pilot member cannot be inserted through the plurality of misaligned holes, the method further comprises:
attempting to insert a second pilot member into the plurality of misaligned holes, the second pilot member being connected to a second reamer having a first portion and a second portion, the second portion having a first end and a second end with the first end being adjacent to the first portion of the second reamer, the first portion of the second reamer having a third constant diameter and the second portion of the second reamer being tapered having a varied diameter that decreases from the first end to the second end, wherein the second pilot member is connected to the second end of the second portion of the second reamer and wherein the second pilot member has a fourth constant diameter that corresponds to a second virtual hole and wherein the third constant diameter of the second reamer corresponds to a second cleanup hole that accepts a second fastener; and
cutting the second cleanup hole through the plurality of misaligned holes with the second reamer as the second pilot member is inserted into the plurality of misaligned holes.

19. The method of claim 18, wherein if the second pilot member cannot be inserted through the plurality of misaligned holes, the method further comprises:
attempting to insert a third pilot member into the plurality of misaligned holes, the third pilot member being connected to a third reamer having a first portion and a second portion, the second portion having a first end and a second end with the first end being adjacent to the first portion of the third reamer, the first portion of the third reamer having a fifth constant diameter and the second portion of the third reamer being tapered having a varied diameter that decreases from the first end to the second end, wherein the third pilot member is connected to the second end of the second portion of the third reamer and wherein the third pilot member has a sixth constant diameter that corresponds to a third virtual hole and wherein the fifth constant diameter of the third reamer corresponds to a third cleanup hole that accepts a third fastener; and
cutting the third cleanup hole through the plurality of misaligned holes with the third reamer as the third pilot member is inserted into the plurality of misaligned holes.

20. The method of claim 17, inserting a first oversize fastener through the first cleanup hole.
